(19) United States
(12) Patent Application Publication
(10) Pub. No.: US 2017/0050474 A1
(43) Pub. Date: Feb. 23, 2017

(54) TIRE COMPRISING A STRIP OF DAMPING FOAM

(71) Applicants: COMPAGNIE GENERALE DES ETABLISSEMENTS MICHELIN, CLERMONT- FERRAND (FR); Michelin Recherche et Technique S.A., GRANGES-PACCOT (CH)

(72) Inventor: PHILIPPE LAUBRY, CLERMONT-FERRAND (FR)

(73) Assignees: COMPAGNIE GENERALE DES ETABLISSEMENTS MICHELIN, CLERMONT- FERRAND (FR); Michelin Recherche et Technique S.A., GRANGES-PACCOT (CH)

(21) Appl. No.: 15/307,233

(22) PCT Filed: Apr. 28, 2015
(86) PCT No.: PCT/EP2015/059198

§ 371 Date: Oct. 27, 2016

(30) Foreign Application Priority Data
Apr. 30, 2014 (FR) 1453943
Jun. 10, 2014 (FR) 1455220

(51) Int. Cl. B60C 19/00; C08J 5/12; C09J 5/00

(52) U.S. Cl. CPC B60C 19/002; C09J 5/00; C08J 5/128; C09J 171/02

(57) ABSTRACT

Tyre comprising an inner liner facing an internal cavity of the tyre, an adhesive layer positioned on the inner liner and a strip of noise-damping foam attached to the inner liner by the adhesive layer, characterized in that the adhesive layer is based on a silanized polyether.

### FIELD OF THE INVENTION

The present invention relates to tyres, and more particularly to tyres comprising, on their inner surface, a strip of foam intended to damp the cavity noise linked to the resonance of the air contained in the internal cavity of the tyres when rolling.

### PRIOR ART

The development of motor vehicle technology with in particular the appearance of electrically propelled vehicles accentuates the requirements of consumers in terms of acceptable noise in the passenger compartment of vehicles.

Cavity noise may be particularly annoying since it lies in a completely audible frequency range.

It is known to place a damping foam in the internal cavity of tyres, see for example U.S. Pat. No. 7,975,740 B2. However, it is necessary to firmly and durably attach this strip of foam. The presence, at the surface of the inner liner, of mould-release agents or traces of these mould-release agents make many adhesive bonding systems lose their adhesive strength, as document

EP 2 554 617 A2 demonstrates. The foam/inner liner assembly must also withstand difficult running conditions, in particular at high temperatures and also high humidity levels.

The EP document discloses a tyre comprising an inner liner facing an internal cavity of the tyre, an adhesive layer positioned on the inner liner and a strip of noise-damping foam attached to the inner liner by the adhesive layer, in which the adhesive layer is based on a silicone adhesive.

### BRIEF DESCRIPTION OF THE INVENTION

One subject of the invention is a similar tyre characterized in that the adhesive layer is based on a silanized polyether.

The use of such an adhesive layer has the advantage of not comprising any solvent or any isocyanate. It also makes possible to improve the attachment of the foam strip even under humid and hot conditions.

Preferably, the silanized polyether is an alkoxysilane-functional telechelic polyether.

By way of example, the alkoxysilane may be methyldimethoxysilane.

The polyether may advantageously be a polyoxypropylene.

The foam of the damping foam strip is advantageously an open-cell polyurethane foam.

According to one preferential embodiment, the foam strip is a circumferentially continuous strip.

According to another subject, the invention relates to a method of attaching a strip of noise-damping foam to the surface of the inner liner of a new tyre, in which:
a layer of adhesive based on silanized polyether is applied to the surface of the inner liner and/or to the radially outer surface of the foam strip;
the foam strip is positioned against the surface of the inner liner; and
the layer of adhesive is left to crosslink.

Advantageously, before attaching the strip of noise-damping foam to the surface of the inner liner of the tyre,
the surface of the inner liner of said tyre is treated with a high-pressure water jet in order to clean said surface; and
the surface of the inner liner is dried.

This treatment makes it possible to remove most of the mould-release agents used.

### DETAILED DESCRIPTION OF THE INVENTION

In the present description, unless expressly indicated otherwise, all the percentages (%) indicated are % by weight.

Moreover, any range of values denoted by the expression “between a and b” represents the range of values extending from more than a to less than b (i.e. limits a and b excluded) whereas any range of values denoted by the expression “from a to b” signifies the range of values extending from a up to b (i.e. including the strict limits a and b).

### Adhesive Based on Silanized Polyether

The applicant companies have discovered that the use of a novel adhesive family based on silanized polyether makes it possible to improve the adhesive bonding of a strip of polyurethane foam to an inner liner of a tyre based on butyl rubber and comprising, at its surface, traces of the mould-release agents used during the vulcanization of the tyre.

The adhesives used are based on polyoxypropylenes that are methoxysilane-functionalized at the chain end:

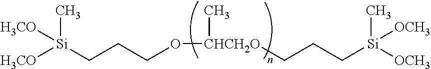

A high-weight polyoxypropylene is firstly functionalized with an alkyl group at each of the two ends of the chain, then is hydrosilylated in order to ultimately obtain a methyldimethoxysilane-functional telechelic polyether.

These polymers combine relatively well the advantages of silicones (ageing resistance) and of polyurethanes (cohesion of the material). They are free of isocyanate and of solvent.

A typical formulation of an adhesive or sealant based on silanized polyether may contain, in addition to the functional polyether: filler(s), plasticizer, pigment, adhesion promoter, dehydrating agent, catalyst, thixotropic agent and optionally antioxidant and/or UV stabilizer depending on the use.

One formulation example (Kaneka DKB-5 sealant)⁽¹⁾ is presented in the table below:

| Type of component | Nature of the component | phr | pcm |
|---|---|---|---|
| Silanized polyether | S303H (Kaneka Corporation) | 100 | 33 |
| (STPE) | | | |
| Filler | Calcium carbonate (CaCO₃) | 120 | 40 |
| Plasticizer | Di-iso-undecyl phthalate (DIUP) | 50 | 16.6 |
| Pigment | White titanium oxide (TiO₂) | 20 | 6.6 |
| Thixotropic agent | Polyamide wax or fumed silica | 5 | 1.7 |
| Dehydrating agent | Vinyltrimethoxysilane | 2 | 0.7 |
| Adhesion promoter | N-2-aminoethyl-3- | 3 | 1 |
| | aminopropyltrimethoxysilane | | |
| Curing catalyst | Dibutyltin bis(acetylacetonate) | 1.5 | 0.5 |
| Total | | 301.5 | 100 |

phr: parts by weight per 100 parts of elastomer, here the silanized polyether; ⁽¹⁾ CABOT—CAB-O-SIL TS-720 in MS-Polymer Sealants (2010)

pcm: percentage by weight relative to 100 g of adhesive.

After application of the adhesive based on silanized polyether (silyl-terminated polyether or STPE), the latter polymerizes with the moisture from the air⁽²⁾.

This polymerization is carried out in two steps:
Step 1: Conversion of the methoxysilane to silanol by hydrolysis:

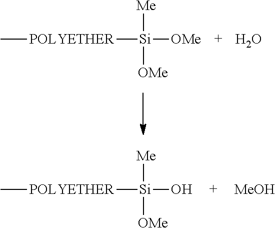

Step 2 : Condensation of the silanol with a methoxysilane in order to form a siloxane bridge:

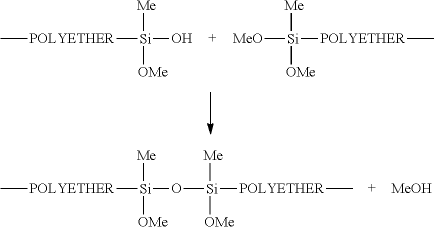

Adhesives based on silanized polyether are available commercially, in particular from the company Bostik: BOSTIK-Simson-ISR-7003, this is a one-component adhesive. ⁽²⁾ CRAY VALLEY—One-component Moisture Curing Methoxysilane Sealants (2001)

### Inner Liner

Butyl rubber is commonly understood to mean a homopolymer of isobutylene or a copolymer of isobutylene with isoprene (this butyl rubber belongs to diene elastomers), and also the halogenated, in particular generally brominated or chlorinated derivatives, of these homopolymers and copolymers of isobutylene and isoprene.

Mention will be made, as examples of butyl rubber particularly suitable for the implementation of the invention, of: copolymers of isobutylene and isoprene (IIR), bromobutyl rubbers such as the bromo-isobutylene-isoprene copolymer (BIIR) and chlorobutyl rubbers such as the chloro-isobutylene-isoprene copolymer (CIIR).

By extension of the preceding definition, copolymers of isobutylene and styrene derivatives such as the brominated isobutylene and methylstyrene copolymers (BIMS) to which in particular the elastomer named EXXPRO sold by the company Exxon belongs, will also be included under the name “butyl rubber”.

Document WO 2012/010667 (A1) comprises in particular examples of a composition formulation for an inner liner based on butyl rubber.

### Polyurethane Foam

The foam of the noise-damping strip is usually an open-cell polyurethane foam. The polyurethane may be based on polyester or on polyether. Preferably, its density is between 0.010 and 0.040 g/cm³.

A commercial example of such a foam is the Metzonor 023 foam from Metzeler Schaum GmbH.

It is a very light flexible strip.

### DESCRIPTION OF THE FIGURES

The sole appended FIGURE very schematically (in particular not to a specific scale) represents an example of a radial cross section of a pneumatic tyre or tyre for a motor vehicle having a radial carcass reinforcement, in accordance with the invention, this tyre being in the cured (i.e. vulcanized) state.

### Tyre with a Strip of Damping Foam

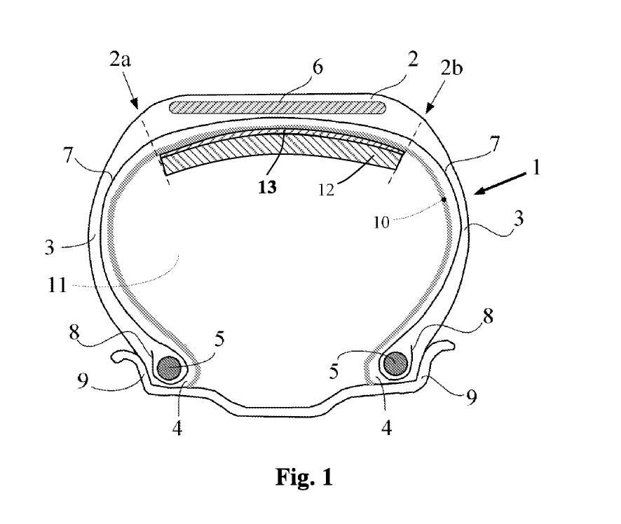

The tyre 1 from FIG. 1 comprises a crown region 2 reinforced by a crown reinforcement or belt 6, two sidewalls 3 and two inextensible beads 4, each of these beads 4 being reinforced with a bead wire 5. The crown region 2, delimited laterally by two shoulders (2a, 2b), is surmounted by a tread (not shown in this schematic FIGURE, for simplification), the belt 6 consisting, for example, of at least two superposed crossed plies reinforced by metal cords. A carcass reinforcement 7 is wound around the two bead wires 5 in each bead 4, the upturn 8 of this reinforcement 7 being for example positioned towards the outside of the tyres, which here are shown fitted on to their rim 9. The carcass reinforcement 7 consists, as is known per se, of at least one ply reinforced by cords referred to as “radial” cords, for example textile or metal cords, i.e. these cords are arranged practically parallel to one another and extend from one bead to the other so as to form an angle of between 80° and 90° with the circumferential mid-plane (plane perpendicular to the axis of rotation of the pneumatic tyre which lies halfway between the two beads 4 and passes through the middle of the crown reinforcement 6).

This tyre 1 also comprises, in a well known manner, an inner rubber layer 10 (commonly referred to as “inner liner”) that defines the radially inner face of the tyre, in contact with the inflation cavity 11. This airtight layer 10 enables the tyre 1 be inflated and kept pressurized. Its airtightness properties enable it to guarantee a relatively low rate of pressure loss, enabling the tyre to be kept inflated, in a normal operating state, for a sufficient duration, normally for several weeks or several months.

This tyre in accordance with the invention has its inner wall 10 at least partly covered, on the side of the cavity 11, with a strip 12 of polyurethane foam capable of partly absorbing the cavity noise. This tyre is characterized in that, between this layer 12 and the inner liner 10, there is a layer of adhesive 13 based on a silanized polyether. The layer of adhesive 13 ensures that the strip of damping foam 12 is kept in place.

In accordance with one possible embodiment of the invention, the layer 12 may cover, still on its radially inner face, one part only of the airtight layer 10, in this case preferably in the crown region of the tyre, as illustrated for example in FIG. 1.

### Positioning a Strip of Damping Foam

The tyre 1 to be fitted with a strip of damping foam is a new tyre, that is to say a vulcanized tyre that is ready to be used. This tyre is selected to be fitted, in an additional manufacturing phase, with a strip of damping foam.

The polyurethane foam is usually manufactured as large-sized blocks then cut by the manufacturer to the dimensions desired for the intended application.

In the example from FIG. 1, the dimensions of the foam strip are of the order of 100 to 150 mm in axial width, of the order of 25 to 35 mm in radial height and having a length of the order of 2 m, i.e. the internal circumference of the inner liner of the tyre.

The first step of positioning the foam strip is, preferably, to clean the internal surface of the tyre, the wall of the inner liner, by means of a high-pressure water jet. This cleaning makes it possible to remove most of the mould-release agents that were placed on this surface before the vulcanization of the tyre in order to facilitate the debonding of the vulcanizing mould curing bladder from the tyre.

After the cleaning, the surface of the inner liner is dried.

A layer of adhesive based on silanized polyether is then applied to the surface of the inner liner and/or to the radially outer surface of the foam strip. This application may consist of applying one or more beads of adhesive either in a helical shape or in a sinusoidal shape. It is also possible to apply a uniform layer over all of the contact surfaces. An application of the adhesive by spraying is also possible: in this case it may be carried out at high temperature in order to favour the spraying technique (drop in the viscosity of the adhesive).

The strip of foam is positioned against the surface of the inner liner.

Preferably, the two contact surfaces of the inner liner and of the foam are pressed, for example by stitching.

Then, the layer of adhesive is left to crosslink at ambient temperature as was described above.

The foam strip may first be formed into a ring by adhesively bonding the two ends; this adhesive bonding may also be carried out after positioning in the tyre.

Positioning a foam strip as described above is only one exemplary embodiment. It is also possible to adhesively bond several continuous or non-continuous foam strips of uniform or non-uniform geometries, as described for example in document EP 1 381 528 B1, using an adhesive based on silanized polyether.

The crosslinking of the layer of adhesive creates two high-quality bonds: the first is the bond between the polyurethane foam and the adhesive, this bond is linked to an interpenetrating network through the open cells of the polyurethane foam; the second is the bond between the adhesive and the inner liner, this bond also being linked to an interpenetrating network originating from the polycondensation of the alkoxysilane-functional oligomers.

Specifically, the macromolecular chains of the inner liner and of the silanized polyether adhesive are partially compatible which enables an intermolecular diffusion between the macromolecular chains to take place when the adhesive bead is bought into contact against the inner liner.

Furthermore, this diffusion is favoured on the one hand by the good mobility of the (not yet crosslinked) silanized polyether and on the other hand by the presence of small molecules such as the adhesion promoter, the dehydrating agent and even the plasticizer (the three acting as a pseudo-solvent). Although it is only very superficial, this intermolecular diffusion is capable of ultimately generating an interpenetrating network after crosslinking of the silanized polyether. This entanglement of the molecules of each of the two materials, with disappearance of the interface and creation of an interphase over a small thickness, must be responsible for the good adhesion observed and measured.

### Tests

### Manual Peel Test

A bead of adhesive was placed on a strip of tyre (cross section) of around 25 mm wide and 200 mm long, then the adhesive was spread with a spatula, a strip of foam of similar dimensions was bought into contact and then pressed against the strip of tyre by stitching.

After crosslinking of the adhesive, the test specimens thus produced were peeled manually in order to determine the site of the failure.

Humid ageing and fatigue tests

The test specimens produced for the humid ageing tests and the fatigue tests consist of a strip of tyre (cross section) of around 25 mm wide and 200 mm long, on which is deposited (internal side of the inner liner) a bead of adhesive of 4 mm in diameter at the centre and over the entire length. The advantage of depositing a bead rather than producing a complete inner liner/adhesive/polyurethane foam assembly is to work on the bond between the adhesive and the inner liner. Specifically, this bond is more structural and has a greater performance than the adhesive/foam bond. The bead peel results are therefore thus more discriminating than the peel values of a complete assembly with an adhesively bonded foam strip.

Fatigue tests were also carried out.

The strips resulting from cross sections of tyre were stressed under the following conditions, the beads of adhesive remaining free:
dynamic alternating torsion test;
angle variable between +6 and −6 degrees;
stress frequency: 20 Hz;
ambient temperature: 60° Celcius;
humidity: 100% relative humidity (RH);
number of cycles: 5×10⁶ (three days of testing approximately).

### Test Results

A comparison of the adhesive bonding performance between an inner liner and a polyurethane foam was carried out in the case of an adhesive based on silicone and an adhesive based on a silanized polyether:
silicone adhesive: HENKEL-Loctite-5970 (one-component);
silanized polyether adhesive: BOSTIK-Simson-ISR-7003 (one-component);
polyurethane foam referenced: METZELER-Metzonor-023 (information from the METZELER data sheet: density =23±2 kg/m³ (NF EN ISO 845) and compression set <10% (NF EN ISO 1856)).

A first manual peel test was carried out after four days of drying the adhesive layers. The results show that for both adhesives, the foam tears. There is a cohesive failure in the polyurethane foam.

Table 1 below gives the adhesive bonding results after humid ageing.

TABLE 1

| | | | | BOSTIK |
|---|---|---|---|---|
| | | | | Simson |
| | | | HENKEL | ISR 7003 |
| | | | Loctite 5970 | silanized |
| | | | silicone | polyether |
| Ambient | 12 days at 23° C. | Peel strength | 14.0 | 24.7 |
| temperature | and 50% RH | (N/cm) | | |
| (control) | | Failure | Cohesive | Cohesive |
| | | pattern | failure | failure |
| Humid | First 6 days at 23° C. | Peel strength | 7.0 | 39.9 |
| ageing | and 50% RH then | (N/cm) | | |
| | 6 days at 70° C. and | Failure | Cohesive | Cohesive |
| | 100% RH | pattern | failure | failure |

RH: relative humidity

The adhesive joints for the adhesive based on silanized polyether, and for the silicone adhesive, are not impaired by the humid ageing and even have higher peel values while retaining an advantageous failure pattern: in all cases a cohesive failure is observed in the adhesive and not an adhesive failure at the interface between the inner liner and the bead of adhesive.

Table 2 gives the results of the comparison after a fatigue test.

TABLE 2

| | | | | BOSTIK |
|---|---|---|---|---|
| | | | | Simson |
| | | | HENKEL | ISR 7003 |
| | | | Loctite 5970 | silanized |
| | | | silicone | polyether |
| Fatigue | Control without | Peel strength | 18.4 | 22.7 |
| test | fatigue (control | (N/cm) | | |
| | from Table 1) | | | |
| | 3 days at 60° C., | Peel strength | 25.8 | 42.0 |
| | 100% RH and | (N/cm) | Cohesive | Cohesive |
| | 5 million cycles | Failure | failure | failure |
| | | pattern | | |

The peel results after the fatigue test demonstrates very good behaviour of the adhesive based on a silanized polyether. The control without fatigue makes possible to confirm the good reproducibility of the adhesive bonding and consequently to guarantee a good confidence brought to all of the adhesion results regarding this family of adhesives.

1-14. (canceled)

15. A tire comprising:
an inner liner facing an internal cavity of the tire;
an adhesive layer positioned on said inner liner; and
a strip of noise-damping foam attached to said inner liner by said adhesive layer, wherein the adhesive layer is based on a silanized polyether.

16. The tire according to claim 05, wherein the silanized polyether is an alkoxysilane-functional telechelic polyether.

17. The tire according to claim 16, wherein the alkoxysilane is methyldimethoxysilane.

18. The tire according to claim 15, wherein the polyether is a polyoxypropylene.

19. The tire according to claim 15, wherein the foam of the damping foam strip is an open-cell polyurethane foam.

20. The tire according to claim 15, wherein the strip is a circumferentially continuous strip.

21. A method of attaching a strip of noise-damping foam to the surface of an inner liner of a new tire comprising the steps of:
applying a layer of adhesive based on silanized polyether to a surface of the inner liner, to a radially outer surface of the foam strip or to both the surface of the inner liner and the radially outer surface of the foam strip;
positioning the foam strip against the surface of the inner liner; and
leaving the layer of adhesive to crosslink.

22. The method according to claim 21 further comprising the steps of:
treating the surface of the inner liner of said tire with a high-pressure water jet in order to clean said surface;
drying the surface of the inner liner; and
attaching the strip of noise-damping foam to the surface of the inner liner of the tire.

23. The method according to claim 21, wherein the silanized polyether is an alkoxysilane-functional telechelic polyether.

24. The method according to claim 21, wherein the alkoxysilane is a methyldimethoxysilane.

25. The method according to claim 21, wherein the polyether is a polyoxypropylene.

26. The method according to claim 21, wherein the foam of the strip of noise-damping foam is an open-cell polyurethane foam.

27. The method according to claim 21, wherein the strip is a circumferentially continuous strip.

28. The method according to claim 21, wherein the adhesive is applied by spraying.
